(19) United States
(12) Patent Application Publication
(10) Pub. No.: US 2004/0079605 A1
(43) Pub. Date: Apr. 29, 2004

(54) Rotational element for automatic transmission

(75) Inventors: Hirofumi Itoh, Shizuoka (JP); Kiyokazu Ichikawa, Shizuoka (JP)

Correspondence Address: SUGHRUE MION, PLLC, 2100 Pennsylvania Avenue, NW, Washington, DC, 20037-3213, US

(73) Assignee: NSK-WARNER KABUSHIKI KAISHA

(21) Appl. No.: 10/403,523

(22) Filed: Apr. 1, 2003

(30) Foreign Application Priority Data
Apr. 1, 2002 (JP) P.2002-098436

(51) Int. Cl. F16D 3/34

(52) U.S. Cl. 192/45

(57) ABSTRACT

The present invention provides a rotational element for an automatic transmission having at least one kind of grooves that are deeper from the outer diameter side to the inner diameter side, grooves that are deeper toward a rotational direction, and grooves that are deeper from the outer diameter side to the inner diameter side, and toward the rotational direction.

### BACKGROUND OF THE INVENTION

1. Field of the Invention

The present invention relates to a rotational element for an automatic transmission.

2. Prior Art

An automatic transmission consists of a rotational element and a non-rotational element disposed adjacently and opposed to each other, and is mostly of wet type. A wet multiple disk clutch 10 as shown in FIG. 1 comprises a clutch case 1, a hub 2, a friction plate 3, a separator plate 4, a retaining ring 5, a piston 6, a leaf spring 7, and a packing plate 8. In an illustrated example, the friction plate 3 is engaged with a spline groove 21 of the hub 2, and the separator plate 4 is engaged with a spline groove 11 of the clutch case 1.

When the clutch is fastened, the friction plate 3 and the separator plate 4 are pressed via the leaf spring 7 against the packing plate 8 by pressing the piston 6 to the left in the figure with oil pressure, thereby transmitting a motive power between the clutch case 1 and the hub 2. When the clutch is released, the piston 6 is returned to the right.

When the clutch is released, the friction plate 3 and the separator plate 4 are placed adjacently and opposed to each other, in which one is rotated and the other is restrained. The clutch of wet type filled with a lubricating oil causes a dragging torque due to a viscosity of the oil.

Thus, the rotational element may be provided with a groove to produce a kinetic pressure while rotating, whereby the rotational element and the non-rotational element are separated to reduce the dragging torque. FIG. 14 is a front view of the friction plate 3 provided with grooves in a conventional example, and FIG. 15 is a cross-sectional view of FIG. 14 taken along the line O-B. Reference numeral 31 denotes a frictional member, 32 denotes a core plate, and 61 denotes a spline tooth around the inner circumference of the core plate.

In the conventional example, the frictional member 31 is provided with grooves 60 having a uniform depth on the surface thereof, whereby the rotational element produces a kinetic pressure owing to the grooves 60 while rotating. Due to this kinetic pressure, the rotational element and the non-rotational element are separated from each other to reduce the dragging torque. However, the conventional groove had a drawback that the dragging torque is not sufficiently reduced while the rotational element is being rotated at high rate.

As described above, most of the automatic transmission has a wet type structure in which the rotational element and the non-rotational element are disposed adjacently, whereby there is a need for suppressing the dragging torque caused while the rotational element is being rotated.

Therefore, it is required to reduce the dragging torque by separating the rotational element and the non-rotational element using a kinetic pressure produced in the oil while the rotational element is being rotated.

### SUMMARY OF THE INVENTION

It is an object of the present invention to provide a rotational element for an automatic transmission in which even when the rotational element and the non-rotational element are disposed adjacently and opposed to each other, a dragging torque produced due to a viscosity of lubricating oil is reduced to prevent a failure or malfunction from arising by rotation of the non-rotational element.

The present invention has been achieved to solve the above object, and provides a rotational element for an automatic transmission having at least one kind of grooves that are deeper from the outer diameter side to the inner diameter side, grooves that are deeper toward a rotational direction, and grooves that are deeper from the outer diameter side to the inner diameter side, and toward the rotational direction.

The rotational element maybe a friction plate, a separator plate or a clutch case of a wet multiple disk clutch for an automatic transmission, a stator for a torque converter, or a one-way clutch.

### BRIEF DESCRIPTION OF THE DRAWINGS

FIG. 1 is a cross-sectional view showing the constitution of a wet multiple disk clutch;

FIG. 2 is a perspective view showing a first kind groove of the present invention;

FIG. 3 is a perspective view showing a second kind groove of the present invention;

FIG. 4 is a perspective view showing a third kind groove of the present invention;

FIG. 5 is a perspective view showing another form of the third kind groove;

FIG. 6 is a front view of a friction plate of the present invention;

FIG. 7 is a cross-sectional view of FIG. 6 taken along the line O-A;

FIG. 8 is a front view of a one-way clutch of the present invention;

FIG. 9 is a cross-sectional view of FIG. 8 taken along the line O-C;

FIG. 10 is a front view of a stator of the present invention;

FIG. 11 is a cross-sectional view of FIG. 10 taken along the line O-D,

FIG. 12 is a cross-sectional view of a clutch case of the present invention;

FIG. 13 is a rear view of FIG. 12 as seen from the R direction;

FIG. 14 is a front view of a conventional friction plate; and,

FIG. 15 is a cross-sectional view of FIG. 14 taken along the line O-B.

### DETAILED DESCRIPTION OF THE PREFERRED EMBODIMENTS

FIGS. 2 to 5 show a groove portion of a friction plate in various groove forms of the present invention, in which reference numeral 31 denotes a frictional member and 32 denotes a core plate.

A groove 33 of FIG. 2 is deeper from the outer diameter side to the inner diameter side, in which reference numeral 36 denotes an inclined surface and 37 denotes a bottom surface. A groove 34 of FIG. 3 is deeper toward a rotational direction R, in which 38 denotes an inclined bottom surface and 39 denotes a side surface.

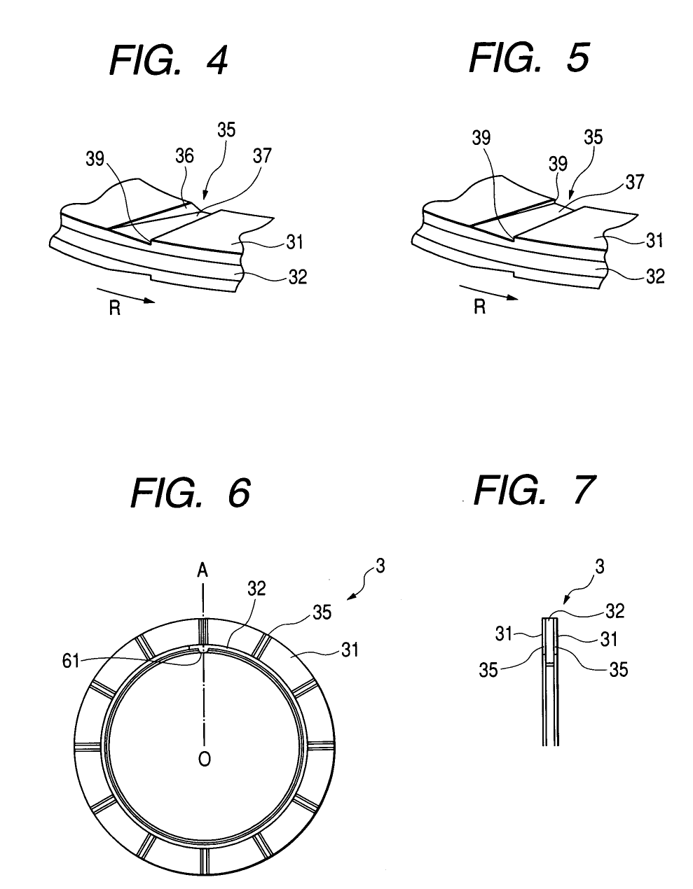

A groove 35 of FIG. 4 is deeper from the outer diameter side to the inner diameter side, and toward the rotational direction R, in which 36 denotes an inclined side surface, 37 denotes a bottom surface, and 39 denotes a side surface. The groove 35 of FIG. 5 is another form of the groove 35 of FIG. 4, and has the bottom surface 37 and both the side surfaces 39, without the inclined side surface.

A rotational element for an automatic transmission of the present invention is provided with the groove deeper from the outer diameter side to the inner diameter side (hereinafter referred to as a first kind groove), the groove deeper toward the rotational direction (referred to as a second kind groove), or the groove deeper from the outer diameter to the inner diameter side, and forward the rotational direction (referred to as a third kind groove).

The first kind groove is designated by numeral 33 in FIG. 2, the second kind groove is designated by numeral 34 in FIG. 3, and the third kind groove is designated by numeral 35 in FIGS. 4 and 5.

FIG. 6 is a front view of the friction plate 3 of the present invention, and FIG. 7 is a cross-sectional view of FIG. 6 taken along the line O-A, in which reference numeral 31 denotes the frictional member, 32 denotes the core plate, and 61 denotes a spline tooth around the inner circumference of the core plate.

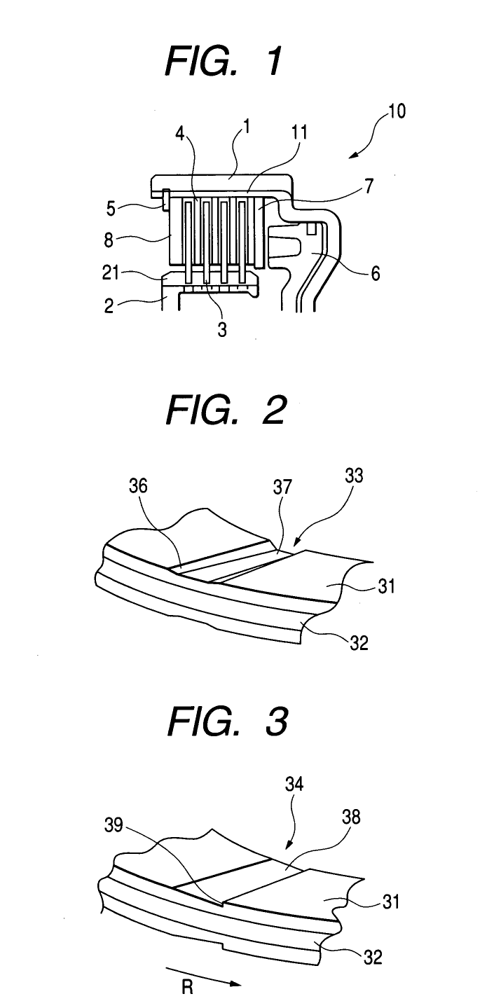

In FIG. 1, when a motive power is transmitted from a hub 2 to a clutch case 1, the friction plate 3 is being rotated at high speed due to engagement between a spline tooth 21 and the spline groove 61 (FIG. 6) around the inner circumference of the core plate 32, while the separator plate 4 stands still in a state where the clutch is opened. However, the friction plate 3 as shown in FIG. 7 is provided with the third kind groove 35 on the frictional member 31, in which a kinetic pressure is produced by the groove 35 to act to separate the separator plate 4, thereby reducing a dragging torque and preventing the separator plate from being dragged and rotated.

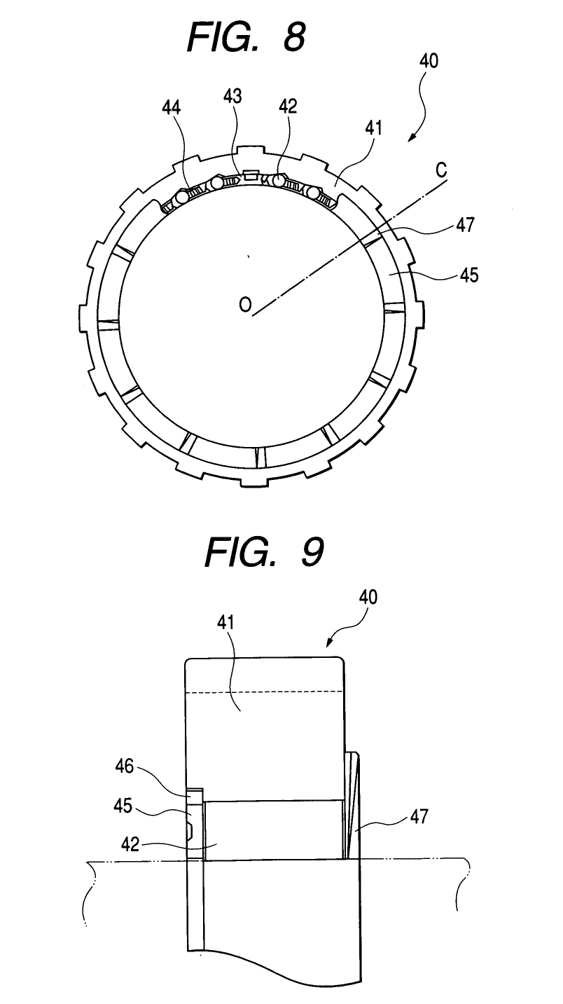

FIG. 8 is a front view of a one-way clutch 40 that is one of the elements constituting an automatic transmission, partly broken away, and FIG. 9 is a cross-sectional view of FIG. 8 taken along the line O-C, in which a roller is employed as a transmission member in an illustrated example, and an inner ring is not shown. Reference numeral 41 denotes an outer ring, 42 denotes a roller, 43 denotes a block bearing between the outer ring 41 and the inner ring (not shown), 44 denotes a spring for biasing the roller, and 45 denotes a holder that is engaged in the outer ring by an engaging portion 4 6 and rotated together with the outer ring 41. Reference numeral 47 denotes a groove provided on the surface of the holder 45, this groove 47 being any of the first to third kind grooves.

Due to the action of the groove 47, a partner member (not shown) provided adjacently opposed to the holder 45 stands still, and is a non-rotational element, whereby a dragging torque with the partner member is reduced even when the outer ring is being rotated.

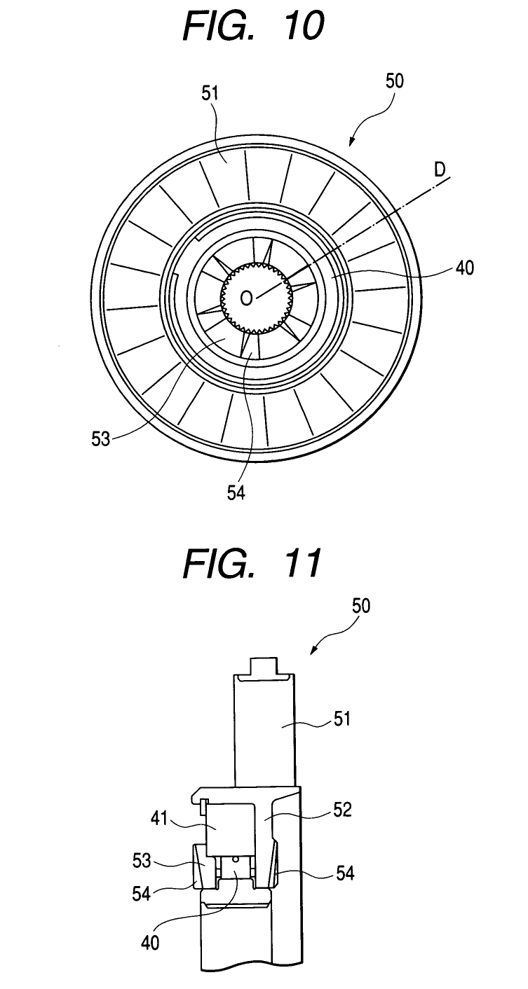

FIG. 10 is a front view of a stator for a torque converter that is one of the elements constituting the automatic transmission, and FIG. 11 is a cross-sectional view of FIG. 10 taken along the line O-D, in which 51 denotes an impeller, 52 denotes an impeller boss portion, and 53 denotes a bushing. Reference numeral 40 denotes the one-way clutch that is one part of the stator. The impeller 51, the impeller boss portion 52, the bushing 53 and the outer ring 41 of one-way clutch are rotated together or stand still.

On an opposed surface between the impeller boss portion 52 and the partner member of the bushing 53, any one of the first kind to the third kind grooves is provided to reduce a dragging torque, even when the stator is rotated. Reference numeral 54 denotes a groove.

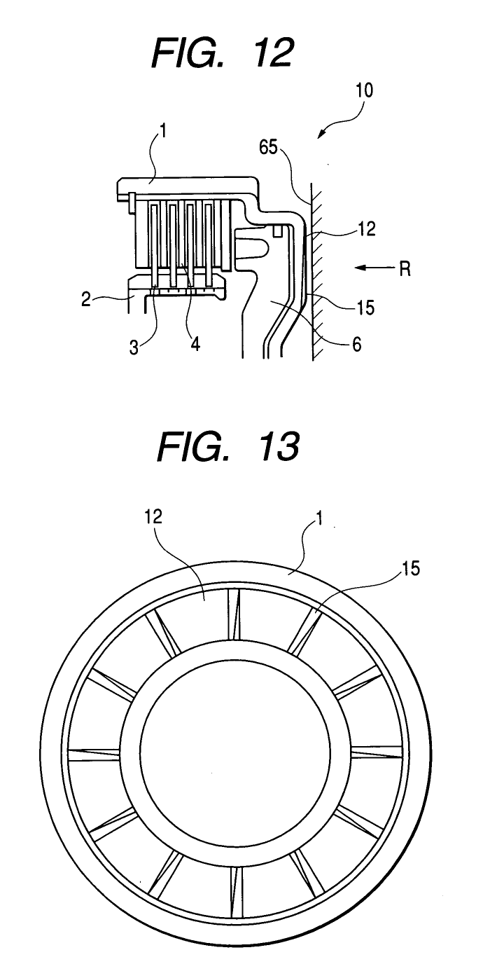

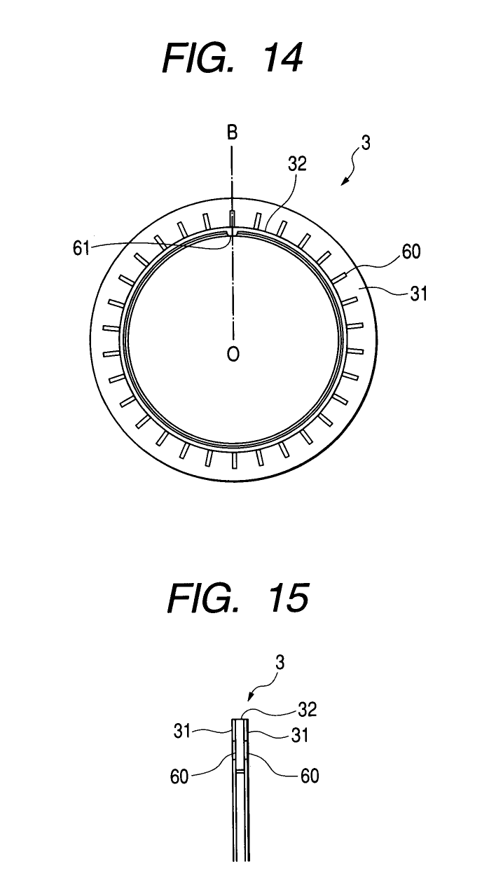

FIG. 12 is a cross-sectional view of a wet multiple disk clutch 10 like that as shown in FIG. 1, in which the same numerals designate the same parts as in FIG. 1. FIG. 13 is a rear view of a clutch case of FIG. 12 as seen from the R direction. The wet multiple disk clutch 10 as shown in FIG. 12 is provided with any of the first to third kind grooves on a rear surface 12 of the clutch case 1 opposed to a partner member 65, thereby reducing a dragging torque with the partner member 65, when the clutch case 1 is rotated. Reference numeral 15 denotes a groove on the rear surface 12 of the clutch case. When a motive power is transmitted from the clutch case 1 to the hub 2, the separator plate 4 serves as a rotational element in a state where the clutch is released, whereby the separator plate is also provided with any of the first to third kind grooves.

The rotational element for the automatic transmission of the present invention is constituted in the above manner, even when the rotational element and the non-rotational element are disposed adjacently and opposed to each other, it is possible to reduce a dragging torque produced due to viscosity of a lubricating oil, and prevent anon-conformity such as a failure from arising due to rotation of the non-rotational element.

What is claimed is:

1. A rotational element for an automatic transmission having grooves that are deeper from the outer diameter side to the inner diameter side.

2. The rotational element for the automatic transmission according to claim 1, wherein said rotational element is a separator plate or a clutch case of a wet multiple disk clutch for an automatic transmission, a stator for a torque converter, or a one-way clutch.

3. A rotational element for an automatic transmission having grooves that are deeper toward a rotational direction.

4. The rotational element for the automatic transmission according to claim 3, wherein said rotational element is a separator plate or a clutch case of a wet multiple disk clutch for an automatic transmission, a stator for a torque converter, or a one-way clutch.

5. The rotational element for the automatic transmission according to claim 1, wherein said grooves are deeper toward a rotational direction of the rotational element.

6. The rotational element for the automatic transmission according to claim 5, wherein said rotational element is a friction plate, a separator plate or a clutch case of a wet multiple disk clutch for an automatic transmission, a stator for a torque converter, or a one-way clutch.
